(19) United States
(12) Patent Application Publication
(10) Pub. No.: US 2001/0030665 A1
(43) Pub. Date: Oct. 18, 2001

(54) Method and system for the visualization of three-dimensional objects

(76) Inventor: Norbert Zimmermann, Hameln (DE)

Correspondence Address: Rocco S. Barrese, Esq., Dilworth & Barrese, LLP, 333 Earle Ovington Blvd., Uniondale, NY, 11553, US

(21) Appl. No.: 09/780,656

(22) Filed: Feb. 9, 2001

(30) Foreign Application Priority Data
Feb. 10, 2000 (DE) 100 05 881.7

(51) Int. Cl. G09G 5/00; G06F 15/16; G06F 17/60

(52) U.S. Cl. 345/849; 709/203; 705/27

(57) ABSTRACT

The present invention relates to a method and system for the visualization of three-dimensional objects via a network, wherein object data are made available to a visualizing station connected to the network and the object data are converted into a graphical representation of the objects by the visualizing station. It is provided in accordance with the invention that the object data are split into static data and dynamic data, that first the static data are made available to the visualizing station off-line and are stored there, that the dynamic data are transmitted respectively for visualization online via the network and are made available to the visualizing station and that the dynamic data and the static data are joined by the visualizing station and converted into the three-dimensional graphical representation of the objects.

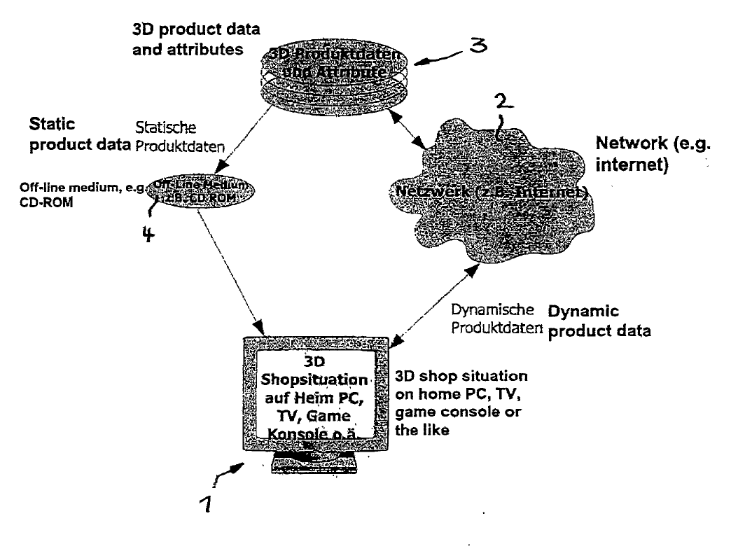

The present invention relates to a method for the visualization of three-dimensional objects via a network, wherein object data are made available to a visualizing station connected to the network and the object data are converted into a graphical representation of the object by the visualizing station.

The present invention further relates to a system for the visualization of three-dimensional objects with a visualizing station connectable to a network for the conversion of object data into a graphical representation of the objects.

The visualization of three-dimensional scenes can also be carried out with the aid of high-powered graphics workstations in real time, for example in simulators. Simpler three-dimensional visualizations have also become possible in personal computers more recently thanks to the enormous increase in the performance of such systems. This is realized, for example, in more recent computer games which use three-dimensional visualizing techniques. Attempts are now also being made to visualize three-dimensional objects via networks, in particular the Internet. A scene to be transmitted is transmitted to the personal computer in the form of data and rendered with the aid of known visualization algorithms, with the imitation representing the available bandwidth of the network, said bandwidth determining the transmission time of the data in addition to the quantity of data. For this reason, even complex, static three-dimensional scenes with fairly large quantities of data to be transmitted cannot be rendered in an acceptable time via the network accesses currently available in the home area.

This problem is serious in particular for highly realistic three-dimensional product representations such as are the goal of so-called online shops or of business to business communications in the e-commerce area. If such representations or the objects to be rendered are to be subjected to dynamic changes with respect to, for example, their position, their movement, their price or their availability, it becomes necessary to transport large quantities of data over the network. With conventional bandwidths of today's network connections in the home area, which are currently around between 19.2 kBit/sec and 1.5 Mbit/sec, this prevents the visualization of three-dimensional shop situations in real time and causes unacceptably high costs.

The present invention therefore has the object of providing an improved method and an improved system of the kind first given which avoids the disadvantages known from the prior art. In particular, a visualization of three-dimensional objects should be achieved in real time via networks with the improved method and the improved system.

This object is solved in accordance with the invention with respect to the technical method aspects with a method of the kind first given by the object data being split into static data and dynamic data, by first the static data being made available to the visualizing station and being stored there, by the dynamic data being transmitted via the network respectively for visualization and made available to the visualizing station, and by the dynamic data and the static data being joined by the visualizing station and converted into the graphical representation of the object.

The object data required for the three-dimensional visualization are therefore separated into two parts. Only one part of the object data is transmitted via the network. The other, preferably larger, part of the data is initially stored in the access area of the visualizing station so that it can access this part of the object data directly. Only the dynamic data need to be transmitted online via the network. The quantity of data to be transmitted via the network is substantially reduced with respect to previous approaches by the splitting of the object data into two parts and the transmission of only a part of the object data in an online manner, whereby substantial savings in time and costs become possible. The transmission of only a part of the object data via the network is also possible in real time with low bandwidths. Three-dimensional objects, in particular highly realistic e-commerce online shops, can also be visualized three-dimensionally in real time in this way with the performance capability of current networks and personal computers.

In a further development of the invention, the advance transmission of the static data to the visualizing station is carried out off-line, that is not via the network. The static data can in particular be made available by means of a separate data medium on which the static data are stored. For the transmission or making available of static data, transmission media such as CD-ROMs, so-called setup boxes or DVDs can be used as transmission media and furthermore pre-installations on personal computers. Such object data are preferably used as static data which do not change or which change only rarely such as the shape and contour of a product. As the greater part of the object data of an object to be rendered three-dimensionally changes only rarely, this part of the data can be stored in advance at the visualizing station and does not have to be transmitted via the network every time for visualization. Modifications, changes or updates of the static data stored in advance can be made online or off-line. The data-intensive static contents can preferably be updated to the latest state as required, e.g. for product changes.

In a further development of the invention, positional data, movement data and/or attribute data of the object can be transmitted online via the network as dynamic data. Attribute data are understood to be such object data that can change or change quickly such as its price, its availability and the like.

The ratio of dynamic object data transmitted online to the static object data transmitted in advance off-line is preferably selected to be very small so that the dynamic data only make up a very small proportion of the total object data amount. In particular, the dynamic object data to be transmitted online are restricted to data which actually change frequently.

The transmission of the dynamic data can be controlled interactively from the respective visualizing station. The control can be formed similar to the downloading of an internet page such that the dynamic object data are activated in the rendering of the respective object, for example, by a mouse-click technique. They can be transmitted as soon as the respective user downloads the corresponding page.

The above-named object is solved in accordance with the invention with respect to the technical device aspects in a system of the kind first given by a memory device being provided which stores a first part of the object data and is associated with the visualizing station and a transmitting device being provided to transmit a second part of the object data to the visualizing station via the network and by the visualizing station being designed such that it reads the first part of the object data from the memory device, joins the first part and the second part of the object data together and converts them into the graphical representation of the objects.

The visualizing station can advantageously have a control device with which the transmission of the second part of the data is controllable interactively online via the network.

The method described and the system described is used in a particularly advantageous manner in e-commerce online shops and in the three-dimensional visualizing of the corresponding products. The objects to be offered can also be rendered three-dimensionally in real time in a highly realistic manner with network bandwidths and data processing equipment of today's standards.

The invention is further illustrated in the following by way of an embodiment and an associated drawing. The drawing shows a flowchart representation of a system to visualize three-dimensional objects in accordance with a preferred embodiment of the invention.

The drawing shows a conventional screen of a personal computer 1 in the home area which has access to an online shop provider of the e-commerce industry via a network 2, in particular the internet. It is understood that other data processing equipment such as television sets with corresponding data processing units, game consoles or similar can be used instead of the personal computer shown. The usual personal computer will preferably be used.

To offer the user of the personal computer 1 the respective products, the online shop provider makes corresponding object data available to the user which are converted into a graphical rendering on the screen by the personal computer 1 with corresponding visualizing algorithms. The object data made available by the online shop provider comprise three-dimensional product data and attribute data of the corresponding products.

The totality of the object data 3 are supplied to the personal computer in different ways. On the one hand, the online shop provider makes an off-line medium available in the example shown such as a CD-ROM on which the static product data, i.e. the object data which do not change or which change only rarely, are stored. The CD-ROM is installed accordingly by the user of the internet access. An access authorization to the online shop system can be linked to the making available of the CD-ROM 4.

The remaining object data, i.e. the dynamic product data which change more frequently, e.g. prices, availability and the like, are downloaded by the user of the network 2 online from the respective online shop provider via the said network 2. The static product data and the dynamic product data downloaded online are joined together at the personal computer 1 and converted into the corresponding graphical representation of the products on offer.

1. A method for the visualization of three-dimensional objects via a network (2), wherein object data (3) are made available to a visualizing station (1) connected to the network and the object data are converted into a graphical representation of the objects by the visualizing station, characterized in that the object data (3) are split into static data and dynamic data, in that first the static data are made available to the visualizing station (1) and are stored there, in that the dynamic data are transmitted respectively for visualization via the network (2) and are made available to the visualizing station (1) and in that the dynamic data and the static data are joined by the visualizing station (1) and converted into the graphical representation of the object.

2. A method in accordance with the preceding claim, wherein the static data are transmitted to the visualizing station (1) off-line, in particular made available by means of a separate data medium (4) on which the static data are stored.

3. A method in accordance with one of the preceding claims, wherein position data, movement data and/or attribute data of the objects are transmitted as the dynamic data.

4. A method in accordance with one of the preceding claims, wherein the transmission of the dynamic data is controlled interactively by the visualizing station (1).

5. A system for the visualization of three-dimensional objects in accordance with the method in accordance with one of the preceding claims having a visualizing station (1) connectable to a network (2) for the conversion of object data (3) into a graphical representation of the objects, a memory device which stores a first part of the object data and is associated with the visualizing station (1), a transmission device to transmit a second part of the object data to the visualizing station (1) via the network (2), with the visualizing station (1) being designed such that it reads the first part of the object data (3) from the memory device, joins the first part and the second part of the object data (3) together and converts them into the graphical representation of the objects.

6. A system in accordance with the preceding claim, wherein the visualizing station (1) has a control device to control the transmission of the second part of the object data (3).
